(19) United States
(12) Patent Application Publication
(10) Pub. No.: US 2026/0067165 A1
(43) Pub. Date: Mar. 5, 2026

(54) SIMPLIFIED PROVISIONING OF CLOUD ONRAMP SAAS APPLICATIONS

(71) Applicant: Cisco Technology, Inc., San Jose, CA (US)

(72) Inventors: Priyam Saikia, Hayward, CA (US); Shailendra Vinod Pardeshi, Dublin, CA (US); Venkateswaran Mohanasundaram, Cary, NC (US); Chhavi Jain, San Francisco, CA (US); Yogesh Mittal, Sunnyvale, CA (US); Sravani Gunda, Dublin, CA (US); Sanjeev Tondale, Fremont, CA (US)

(73) Assignee: Cisco Technology, Inc., San Jose, CA (US)

(21) Appl. No.: 19/036,756

(22) Filed: Jan. 24, 2025

Related U.S. Application Data
(60) Provisional application No. 63/688,150, filed on Aug. 28, 2024.

(51) Int. Cl. H04L 41/0894; H04L 41/12; H04L 41/22

(52) U.S. Cl. CPC H04L 41/0894; H04L 41/12; H04L 41/22

(57) ABSTRACT

In one aspect, a method includes accessing network topology data associated with a network, where the network topology data identifies a set of network devices, classifying respective network devices of the set of network devices based on a type of network device and interface information associated with the respective network devices, determining default values based on the network topology data and classification of the respective network devices, generating executable code for configuring a policy for the network based on the default values, and implementing the policy on the network.

### CROSS-REFERENCE TO RELATED APPLICATIONS

This application claims the benefit of priority to U.S. Provisional application No. 63/688,150, filed on Aug. 28, 2024, which is expressly incorporated by reference herein in its entirety.

### BACKGROUND

The performance of a Software as a Service (Saas) application is often influenced by how effectively the network routes its traffic. Traditional application-aware routing policies for SaaS applications rely on predefined paths and static routes, which often fail to consider real-time network performance. Traditional application-aware routing also lacks the flexibility to dynamically change paths resulting in suboptimal network path selection. Cloud OnRamp (CoR) for SaaS feature in Catalyst SD-WAN has been introduced to address deficiencies associated with traditional application-aware routing techniques. CoR continuously monitors traffic in real-time and selects the optimal path based on current conditions. CoR for SaaS is heavily reliant on a complex, manual, and prone to error configuration process.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture according to some aspects of the present disclosure;

FIG. 2 illustrates an example flowchart of a process for configuring a network policy according to some aspects of the present disclosure;

FIG. 3 illustrates an example network according to some aspects of the present disclosure;

FIG. 4 illustrates a process for automatically generating a network policy for an application according to some aspects of the present disclosure;

FIG. 5A shows an example user interface for configuring a network policy for an application according to some aspects of the present disclosure;

FIG. 5B shows another example user interface for configuring a network policy for an application according to some aspects of the present disclosure;

FIG. 5C shows another example user interface for configuring a network policy for an application according to some aspects of the present disclosure;

FIG. 5D shows another example user interface for configuring a network policy for an application according to some aspects of the present disclosure; and

FIG. 6 shows an example of a system for implementing certain aspects of the present technology.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to eliminating complexities associated with the configuration process of CoR for SaaS applications. Improved techniques and processes described herein enable an automated and internal handling of this configuration process, generating a trustworthy configuration that guarantees an optimized network for SaaS applications based on a specific/desired deployment policy and/or topology. Auto-configurations save significant time and effort by targeting multiple devices simultaneously and utilizing existing network information to do so. This is in contrast to the manual approach, where the user must analyze and identify sites in the network, leading to a time-consuming, error-prone and less reliable configurations. With just a few clicks from a user, the SD-WAN Manager generates a smart and efficient configuration that ensures a reliable network.

In one aspect, a method includes receiving a request for a network policy, where the request indicates an application; accessing network topology data associated with a network, where the network topology data identifies a set of network devices; classifying respective network devices of the set of network devices based on a type of network device and interface information associated with of the respective network devices; determining default values based on the network topology data and classification of the respective network devices; configuring the policy for the application on the network based on the default values; and implementing the policy for the application on the network.

In another aspect, the method further includes generating a graphical user interface (GUI) configured to display a network device of the set of network devices and selectable set of settings, where a set of default values associated with the network device is preselected in the selectable set of settings.

In another aspect, the method further includes receiving, from a user device via the GUI, a selection of a value of a setting of the selectable set of settings, where the value differs from a default value associated with the setting; modifying, based on the selection, the policy for the network; and implementing the policy in the network based on modifying the policy.

In another aspect, the selectable set of settings includes a set of applications; a set of network policies; and a set of network devices.

In another aspect, modifying the policy for the network includes generating executable code based on the value of the setting, where the executable code is changed to modify the policy.

In another aspect, receiving the selection of the value of at least one of the selectable settings includes receiving a selection of an application, a network policy, and a network device.

In another aspect, implementing the policy on the network includes auto-configuring the network device based on the classification of the network device and the network policy for the application.

In another aspect, implementing the policy includes determining a rule in the network policy based on the application and the network device; determining that the rule conflicts with a default rule of the network policy; and prioritizing the rule for traffic associated with the application.

In another aspect, classifying the set of network devices includes identifying one or more endpoints to be probed for the application; and classifying of the respective network devices by determining a designation for the respective network devices as being one of a gateway, a DIA branch, or a client device.

In one aspect, a system includes at least one memory configured to store instructions; and at least one processor coupled to the at least one memory and configured to execute the instructions toto: receive a request for a network policy, where the request indicates an application; access network topology data associated with a network, where the network topology data identifies a set of network devices; classify respective network devices of the set of network devices based on a type of network device and interface information associated with of the respective network devices; determine default values based on the network topology data and classification of the respective network devices; configure the policy for the application on the network based on the default values; and implement the policy for the application on the network.

In one aspect, a non-transitory computer-readable storage medium includes instructions that, when executed by at least one processor, cause the at least one processor to: receive a request for a network policy, where the request indicates an application; access network topology data associated with a network, where the network topology data identifies a set of network devices; classify respective network devices of the set of network devices based on a type of network device and interface information associated with of the respective network devices; determine default values based on the network topology data and classification of the respective network devices; configure the policy for the application on the network based on the default values; and implement the policy for the application on the network.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for streamlined and effective CoR configuration for any Software-as-a-Service (SaaS) application. For example, the performance of a SaaS application can be reliant on how effectively the network routes such application's traffic. Traditional application-aware (app-aware) routing policies for SaaS applications rely on predefined paths and static routes, which often fail to consider real-time network performance. Further, these traditional policy approaches lack the flexibility to dynamically change paths resulting in suboptimal network path selection.

An SDWAN manager such as COR for SaaS feature in Catalyst SD-WAN can be a tool or system for managing an SDWAN (e.g., routing traffic, implementing policies, monitoring network devices, etc.) Such SDWAN managers continuously monitor traffic in real-time and select the optimal path based on current conditions. By using techniques like probes and network telemetry, these systems constantly adapt to pick the best available path to ensure low latency, high speed, and reliable connections. However, configuring a routing infrastructure using such SDWAN managers can be a complex and time-consuming process, heavily reliant on the expertise of network engineers. For example, to configure and implement a routing policy, a user may need to navigate a number of distinct workflows, each with multiple steps requiring various inputs. Steps in these workflows can include identifying the applications for policy implementation; specifying actions (such as policy or monitoring); defining prefix lists; and reviewing the policy itself. Users may also need to identify and pick gateway devices and configure exit types and other probing details. Once gateways are configured, users may need to repeat the process for their branch and client site devices as well. In some cases, additional steps may be required for features like traffic steering or informed routing.

For the above-described reasons, there is a need for systems and methods for configuring and implementing a policy using an SDWAN manager that are simple and straightforward to use, and that do not require a deep understanding of the network. Disclosed examples address this need by providing a dynamic and simplified platform for configuring and implementing policies. For example, disclosed systems and methods provide a flexible system with robust functionality that can dynamically manage traffic based on real-time data from endpoint probes. The disclosed systems and methods can minimize human error and increase the efficiency of configuring and implementing policies for SaaS applications on a network.

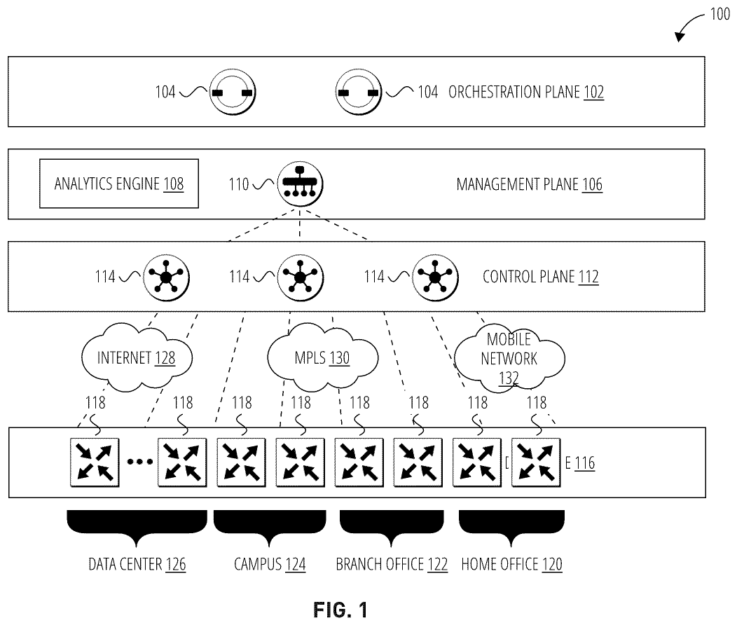

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrators such as the network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include an analytics engine 108 and one or more physical or virtual network management appliances such as the network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances such as the network control appliances 114. The network control appliances 114 can establish secure connections to each of the edge network devices 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges of various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as the internet transport network 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

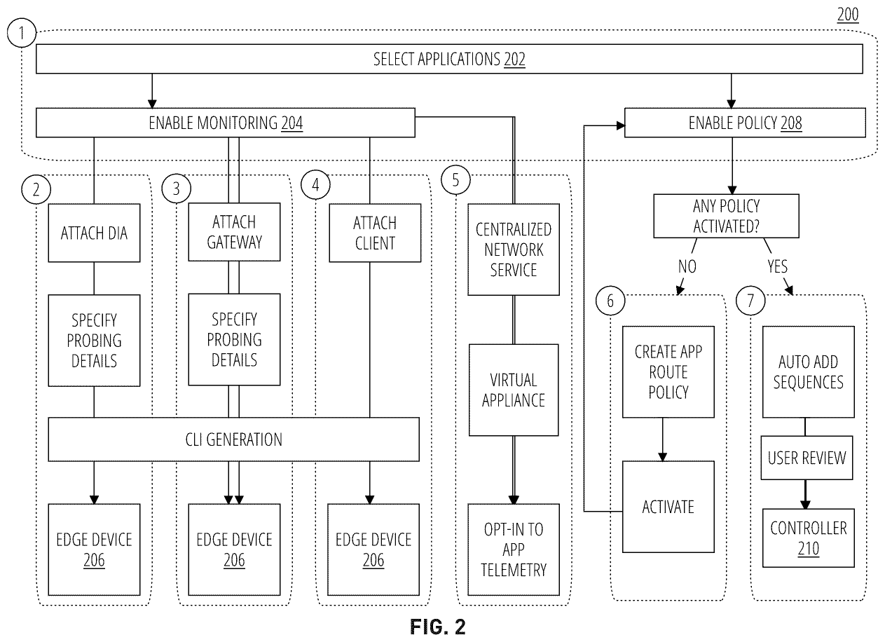

FIG. 2 illustrates a process 200, which is used currently to configure and implement a policy using an SDWAN manager equipped with Cisco CoR for building a routing infrastructure. The SDWAN manager can be used, for example, to dynamically identify the least resistant path in a network for routing traffic associated with a particular application. Thus, the SDWAN manager can determine which of one or more paths is an optimal path at a given time and dynamically switch traffic to that path to optimize performance. However, configuring the SDWAN manager can be a cumbersome process, requiring deep knowledge of the network and network devices.

Each number, one through seven, in FIG. 2 depicts one distinct workflow that has to be completed by a user in order to configure and implement a policy for a SaaS application using currently available methods, e.g., using Cisco CoR. Disclosed systems for SaaS applications can use real-time monitoring data from cloud-based probing to consistently route applications via the most optimal paths. Unlike traditional application-aware routing methods, this approach dynamically adjusts routes based on live network performance. To ensure accurate system optimization and prevent user configuration errors, disclosed systems and methods leverage existing network elements to automatically generate configurations. In some examples, at least six of these workflows are mandatory to have a working SaaS network.

Although the primary input required from users is the list of SaaS applications intended for best path selection (step 202), users are often asked for additional complex network information in order to set up the network policy. For example, to enable monitoring of network devices (step 204) in workflows two through four, the user configuring the SDWAN manager needs to know the network topology and the type of each edge device 206 (e.g., hub, branch, spoke). For example, as shown in workflows two through four, each type of edge device 206 may require different steps to set up monitoring for that type of edge device 206 to enable the SDWAN manager to dynamically determine an optimal path for routing traffic in real-time.

To enable a policy (step 208), a user needs to complete either workflow six or seven. For example, a user may have to create a routing policy for a selected application and activate the policy for the network. If a policy is activated, the user can review the policy and transmit the policy to a controller 210 of the network for implementation.

The disclosed systems and methods facilitate a streamlined process for configuring network policy for any SaaS application incorporating several features, resulting in the following benefits. For example, disclosed systems and methods use existing network information to minimize human errors and offer smart, data-driven defaults to ensure configurations tailored to the customer's use case. Further, disclosed systems and methods facilitate a swift and efficient best-path selection process for SaaS applications compared to traditional methods. The disclosed systems and methods are flexible and provide robust functionality capable of adapting to special circumstances.

In addition, aspects of the present disclosure require minimal input from a user (e.g., a network engineer), eliminating the need for the user to navigate and complete workflows one through seven. The user can specify the SaaS applications they want to monitor and the sites for which these applications need to be optimized. With this information, the user can deploy an automatically configured policy which will be enforced by a network manager. As part of the deployment process, the manager can intelligently identify the role of each site on the network and the most suitable exit path for the application.

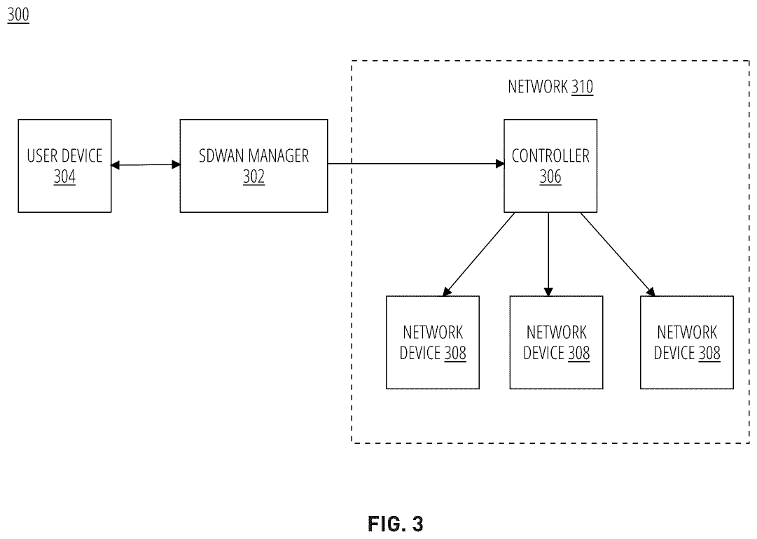

FIG. 3 is an exemplary illustration of a system 300 for managing a policy on a network 310. The network 310 can be, for example, a network having the network architecture 100. The system 300 can include additional components not shown in FIG. 3, or can include fewer components than shown in FIG. 3, or can include any sub-combination of the illustrated components.

The system 300 can include an SDWAN manager 302 that can enable configuring routing policies for one or more SaaS applications on the network 310. The network 310 can include any number of network devices such as the network devices 308, which may be, for example, the same as or similar to the edge network device 118. In some examples, the SDWAN manager 302 can be an SDWAN manager associated with the management plane 106 of the network architecture 100. The SDWAN manager 302 can generate one or more GUIs to be displayed on the user device 304, with the GUIs being configured to receive information needed to configure a policy. The GUIs, which will be explained in further detail below, facilitate the efficient creation and customization of policies for SaaS applications and eliminate the need for the user to complete the process 200 described with reference to FIG. 2.

The SDWAN manager 302 can receive inputs via the user device 304 specifying, for example, for which applications to implement a policy and on what network sites. The SDWAN manager 302 can additionally access network information such as a topology of the network 310 to determine a type of each of the network devices 308 in the network 310. For example, the SDWAN manager 302 can analyze the topology and interface information to determine a type of each of the network devices 308. In some examples, a network device from among the network devices 308 can be a network hub and therefore designated as a gateway, a spoke site device with Direct Internet Access (DIA) links can be designated as a DIA branch, and a spoke site without DIA links can be designated as a client device, or pure branch device. The SDWAN manager 302 can also derive an exit type for each of the network devices 308 based on whether the available exit is via DIA, SIG, or SSE.

Based on the classification of the network devices 308 and any additional specifications, the SDWAN manager 302 can generate a policy for the selected SaaS applications. In some examples, the SDWAN manager 302 can generate a set of preselected default policy values based on the network topology and the device classifications and/or designations. In other examples, the default values can be preselected based on network, system, or device requirements. The SDWAN manager 302 can also identify and manage conflicting policy rules for a SaaS application on the network 310. For example, the SDWAN manager 302 can identify if conflicting rules exist in the generated policy and can ensure that the rule with the SDWAN manager 302 (which may be equipped with CoR) action takes higher precedence for the selected SaaS applications. The SDWAN manager 302 may also intelligently exclude default RFC 1918 traffic from routing optimization by creating higher precedence rules for such default prefixes.

Further, the SDWAN manager 302 can identify applications capable of using third-party telemetry data to perform traffic steering or informed routing and automatically appends such configurations to optimize the network 310. The SDWAN manager 302 can also identify, based on the network topology and device classification/designation, endpoints for inserting probes in the network. Real-time data from the endpoint probes can be used in traffic steering and informed routing to dynamically optimize traffic through the network.

The generated policy can be, or can be associated with, executable code for implementing the policy at the network devices 308. In some examples, the policy can be auto-configured by the SDWAN manager 302 using default values. In some cases, the SDWAN manager 302 can change the executable code associated with the auto-configured policy based on input received modifying one or more policy settings from the default values. Thus, the SDWAN manager 302 can implement changes to the executable code to insert modified setting values.

Accordingly, systems and methods disclosed herein can eliminate the complexity of the configuration process for the user and handle the configuration process internally, thereby generating a configuration that guarantees an optimized network for SaaS applications based on the customer's specific topology. Auto-configurations can save significant time and effort by targeting more than one of the network devices 308 simultaneously and using existing network information. This is in contrast to the manual approach (e.g., the process 200 described with reference to FIG. 2), where manual analysis and identification of each site in the network is required, leading to potential human errors and less reliable configurations. The SDWAN manager 302 of the present disclosure can generate a smart and efficient configuration that ensures a reliable network. Moreover, the disclosed systems and methods introduce easy customization, ensuring the solution remains flexible and capable of adapting to changes or unexpected situations. The SDWAN manager 302 allows customization of smart defaults and also allows addition of more complex rules if the user needs to do so.

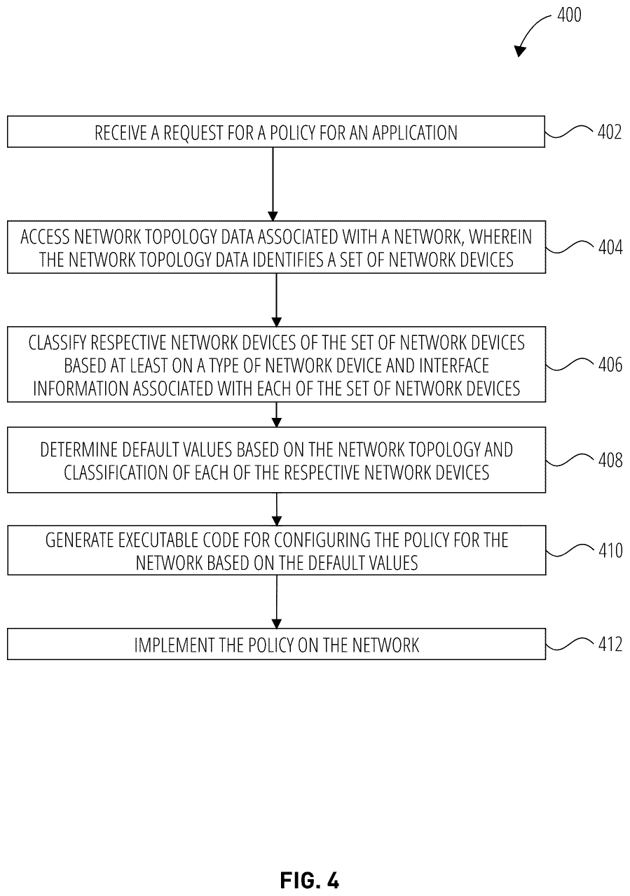

FIG. 4 illustrates a process 400 for configuring and implementing a routing policy for a SaaS application in a network. For example, the process 400 can be used to implement a routing policy for one or more edge network devices such as the edge network devices 118 of the network architecture 100. For example, the process 400 can be executed by a network management appliance 110 or other device of a management plane 106 that can be used for enabling a user to configure a policy for implementation by the control plane 112.

In block 402, process 400 can include receiving, e.g., via a user device 304, a request for a network policy for a selected application. In some examples, the request can be received at the SDWAN manager 302 via a GUI configured on user device 304. The request can be for the SDWAN manager 302 to generate a network policy for the selected application where the policy facilitates optimized routing of traffic associated with the application.

In block 404, process 400 can include accessing, by the SDWAN manager 302, network topology data associated with the network 310. The network topology data can identify a set of network devices (e.g., the network devices 308). The network topology can provide information about the network 310, the network devices 308, and the network structure.

In block 406, process 400 can include classifying respective network devices in the set of network devices. The classification of the respective network devices 308 can be based on a type of the network device and on interface information associated with the respective network devices. For example, the SDWAN manager 302 can identify which sites (e.g., network devices) can act as gateways and which as branches. The network topology can be analyzed along with interface information for each network device. Devices acting as network hubs can be designated as gateways, spoke site devices with DIA links can be designated as DIA branches, and spoke site devices without DIA links can be designated client (pure branch) devices.

In block 408, process 400 can include determining, by the SDWAN manager 302, default values based on the network topology data and classification of the respective network devices 308. In some examples, the default values can be determined using a mapping table or other lookup methods that use, in part, parameters including the input network and device information. In other examples, the default values can be preselected based on system or network requirements. Default values can, for example, indicate whether a network device is a secure internet gateway (SIG), whether to include all DIA interfaces at the network device, or other policy configuration parameters such as load balancing, percent loss, or latency.

In block 410, process 400 can include generating, by the SDWAN manager 302, executable code for configuring a policy for the network 310 using the default values. In some examples, the policy can be one or more executable program codes. For example, the executable code can cause one or more settings of the network 310 to be set to the set of default values. Further, the policy can be customized automatically based on the default values and any custom settings received by the SDWAN manager 302 such that the executable code can cause the default values and any custom settings to be applied to the network 310.

In block 412, the process 400 can include implementing, by the SDWAN manager 302, the generated policy on the network 310. For example, the generated policy can be passed to a controller 306 for execution on the network. Implementing the policy can include, for example, auto-configuring the one or more network devices based on the classification of each of the one or more network devices and the network policy, for the application. The automatically configured policy can enable optimal traffic routing based on network conditions at any given time. In some examples, the policy can be implemented by the SDWAN manager 302 or the controller 306 using the executable code. The SDWAN manager 302 or the controller 306 can run the executable code to apply the policy on the network 310 using the set of default values.

In some examples, the process 400 can further include receiving, from a user device via the GUI, a selection of a value of at least one of the selectable set of settings, where the value differs from a default value associated with the least one of the selectable set of settings; modifying, based on the selection, the policy for the network; and implementing the modified policy in the network. Accordingly, the SDWAN manager 302 can facilitate customization of the generated policy. In some examples, the GUI can display preselected, or preconfigured, default values for each of the selectable settings. In customizing the generated policy, the SDWAN manager 302 may change or modify the executable code of the policy based on the selected settings. Thus, the SDWAN manager 302 can facilitate changes to the generated policy from the default values. Further, the SDWAN manager 302 can be configured to prioritize customized policy rules for traffic on the device if a custom rule conflicts with a default policy rule.

In some examples, the process 400 can further include receiving real-time network data (e.g., traffic data or telemetry data) and steering traffic or performing informed routing based on the real-time data. For example, the SDWAN manager can receive telemetry data from a third-party. Additionally, the SDWAN manager 302 can identify, based on the network topology and device classification/designation, endpoints for inserting probes in the network. The endpoint probes can provide real-time network data used for dynamically routing network traffic.

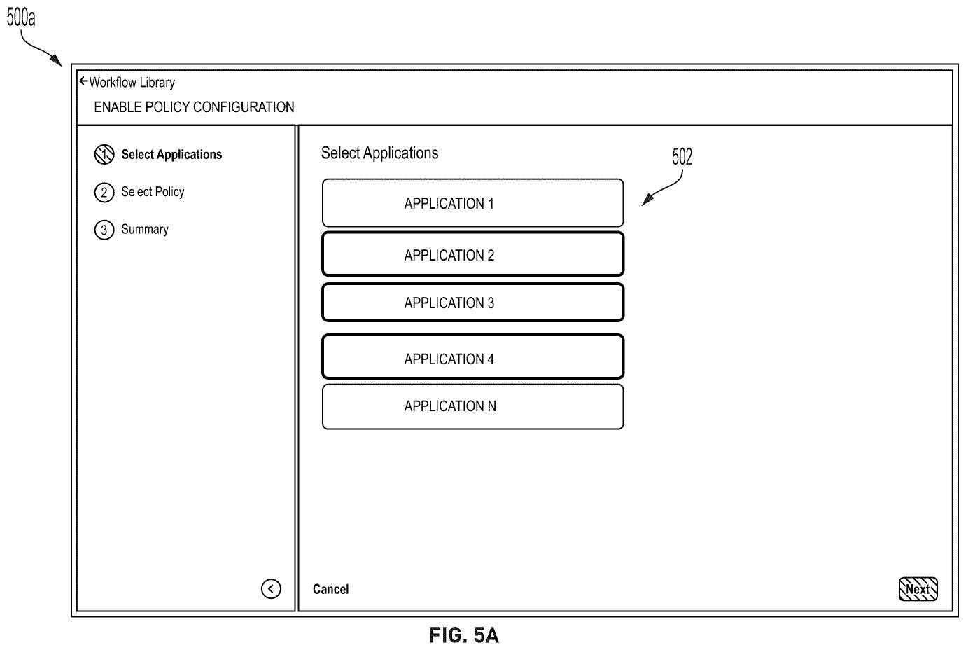

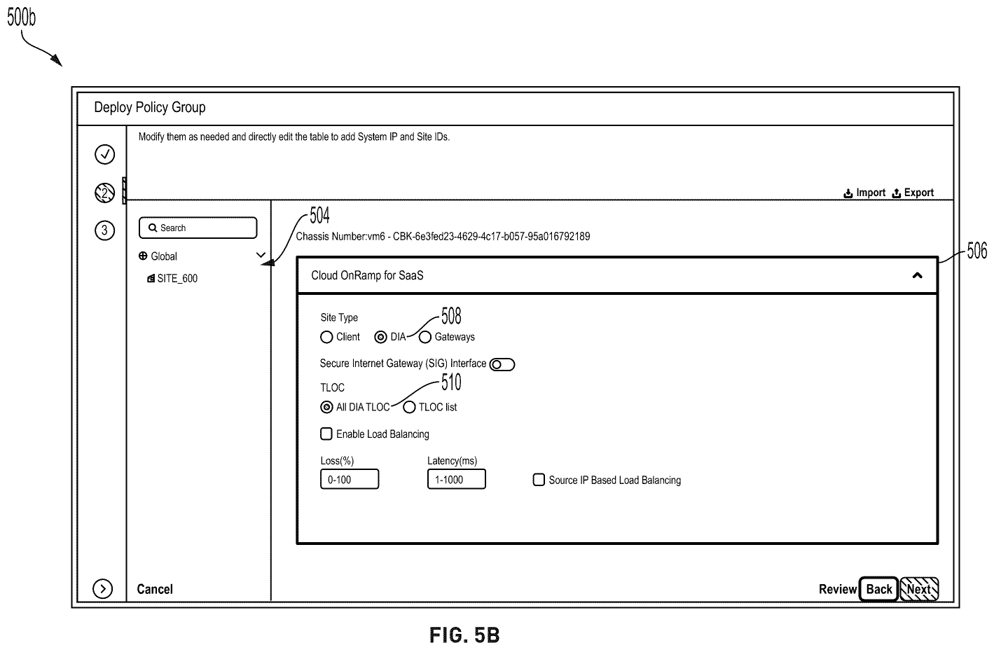

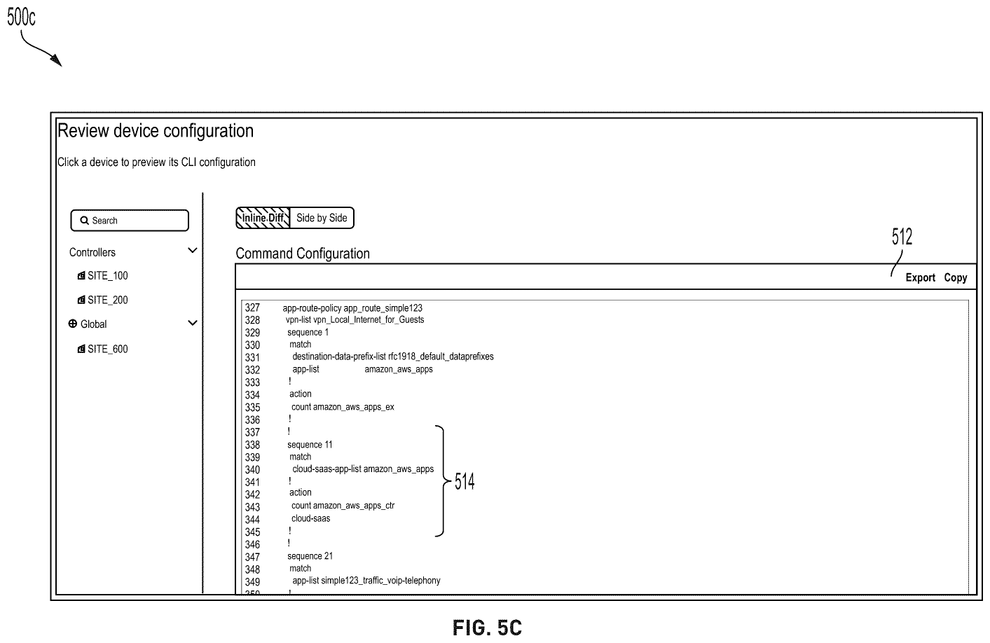

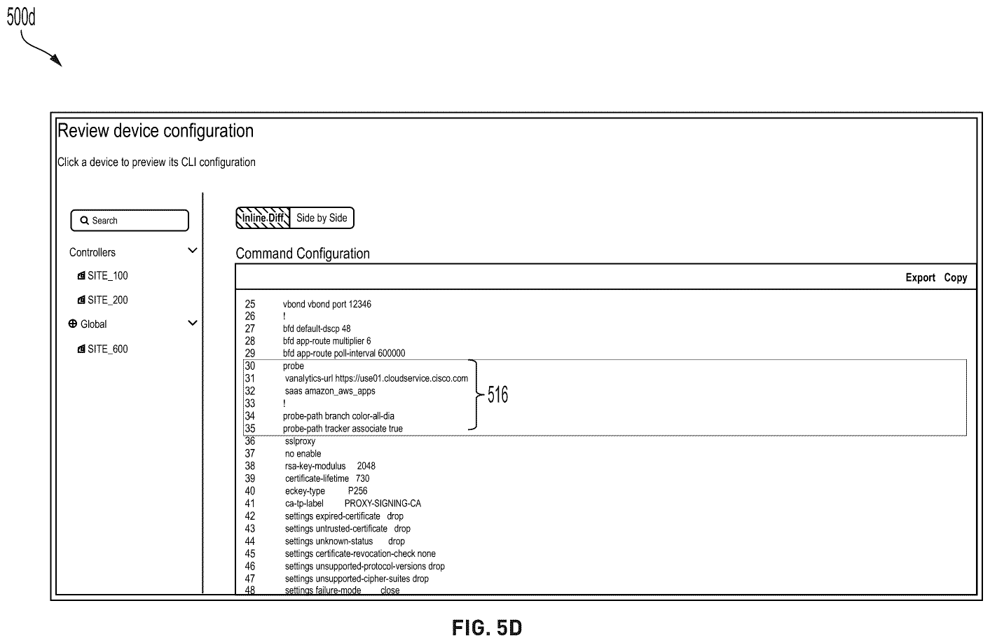

FIG. 5A illustrates an example of a GUI 500a for configuring a network policy for a SaaS application using the disclosed systems and methods. For example, GUI 500a can be displayed via a user device 304 during execution of the process 400. The GUI 500a can enable receiving a selection from a list 502 of SaaS applications available on the network 310. One or more applications from the list 502 may be selected for which auto-configuration may be implemented. Once selected, a next GUI such as, GUI 500b may be displayed, as shown in FIG. 5B.

The GUI 500b can display a list of sites 504 that includes each site, or network device, of the network 310. From the list of sites 504, the policy for each site can be configured. The GUI 500b can then display a window 506 for further configuring the policy for the selected site. In some examples, the window 506 can display policy configuration parameters (e.g., site type, TLOC, load balancing) with preset default values. For example, based on analysis of the network devices and topology by the SDWAN manager 302, the window 506 can have a radio button 508 pre-selected based on the determined type of the site. Additionally, the window 506 can pre-select a radio button 510 to the default selection of “all DIA TLOC.” These pre-selected settings can be customized based on an interaction with the GUI 500b. For example, a user (e.g., a system administrator) can optionally modify a setting from the pre-selected default value (e.g., based on unique network requirements or a desired policy implementation). For example, if radio button 508 is automatically set to “DIA,” a user can change the selection to “Client” or “Gateways,” thereby modifying the automatically configured policy. Further, optional settings like load balancing can be enabled or a particular TLOC set defined by an input or saved TLOC list can be enabled (e.g., optional settings can be activated manually by a user or automatically based on analysis of the network 310 by the SDWAN manager 302).

FIG. 5C illustrates an example of a GUI 500c for reviewing the generated policy prior to implementation. The GUI 500c can include a window 512 for viewing code, or command line input, that is generated to configure a policy. The code can include, for example, a number of sequences (e.g., sequence 514) that provide instructions or configuration details for the applications selected via GUI 500a. In some examples, the configuration details can be used in conjunction with an existing policy, to further customize the policy for a particular application. In some examples, a user can further manually customize the configuration code via the window 512. Further, the user can review the generated policy via the window 512 prior to deploying the policy on the network 310.

FIG. 5D illustrates another example of a GUI 500d that can be displayed via a user device 304 as part of a process (e.g., the process 400). The code section 516 is an example of code that can be generated by the SDWAN manager 302 for configuring a probe for a selected application. For example, the SDWAN manager 302 can automatically generate a probe configuration for a selected application with using the smart-detected exit type of a network device and the device's classification as a DIA branch. The probe can be used to dynamically route application traffic via an optimal path in the network 310 based on detected network conditions. In some examples, the user can further configure or customize the probe configuration code prior to deploying the policy in the network 310.

Once the policy generation is completed via one or more GUIs such as GUI 500a, GUI 500b, GUI 500c, and/or GUI 500d, the user can deploy the policy on the network 310. For example, the policy can be sent to a controller 306 of the network 310 for managing traffic routing among one or more of the network devices 308 for the selected application. Accordingly, disclosed systems and methods provide a platform through which a user can automatically generate a policy through a streamlined process. Disclosed systems and methods further enable the user to customize the policy from pre-selected default settings and to add additional complex rules to the policy, if desired.

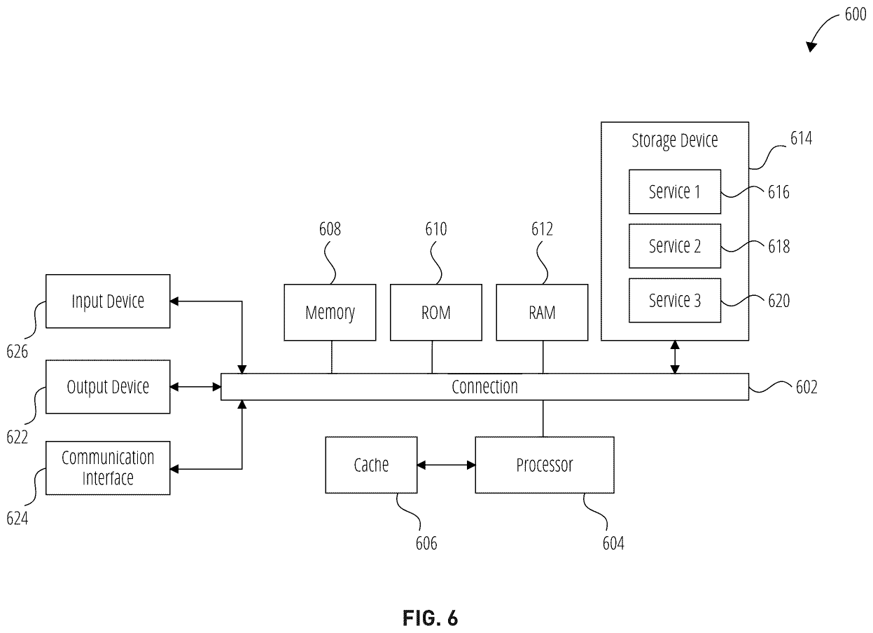

FIG. 6 shows an example of computing system 600, which can be for example any computing device making up the controller-driven architecture of FIG. 1, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (e.g., CPU or processor 604) and connection 602 that couples various system components including system memory 608, such as read-only memory (e.g., ROM 610) and random access memory (e.g., RAM 612) to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
receiving a request for a policy, wherein the request indicates an application;
accessing network topology data associated with a network, wherein the network topology data identifies a set of network devices;
classifying respective network devices of the set of network devices based on a type of network device and interface information associated with the respective network devices;
determining a set of default values based on the network topology data and classification of the respective network devices;
generating executable code for configuring the policy for the application on the network based on the set of default values; and
implementing the policy for the application on the network using the executable code.

2. The method of claim 1, further comprising:
generating a graphical user interface (GUI) configured to display a network device of the set of network devices and selectable set of settings, wherein the set of default values associated with the network device is preselected in the selectable set of settings.

3. The method of claim 2, further comprising:
receiving, via the GUI, a selection of a value of a setting of the selectable set of settings, wherein the value differs from a default value of the set of default values associated with the setting;
modifying, based on the selection, the policy for the network; and
implementing the policy in the network after modifying the policy.

4. The method of claim 2, wherein the selectable set of settings comprises:
a set of applications;
a set of network policies; and
a set of network devices.

5. The method of claim 3, wherein modifying the policy for the network comprises updating the executable code based on the value of the setting, wherein the executable code is changed to modify the policy.

6. The method of claim 3, wherein receiving the selection of the value of the setting comprises receiving a selection of an application, a network policy, and a network device.

7. The method of claim 6, wherein implementing the policy on the network comprises:
auto-configuring the network device based on the classification of the network device and the network policy for the application.

8. The method of claim 6, wherein implementing the policy comprises:
determining a rule in the network policy based on the application and the network device;
determining that the rule conflicts with a default rule of the network policy; and
prioritizing the rule for traffic associated with the application.

9. The method of claim 1, wherein classifying the set of network devices comprises:
identifying one or more endpoints to be probed for each application; and
classifying the respective network devices of the set of network devices by determining a designation for the respective network devices as being one of a gateway, a DIA branch, or a client device.

10. A system comprising:
at least one memory configured to store instructions; and
at least one processor coupled to the at least one memory and configured to execute the instructions to:
receive a request for a policy, wherein the request indicates an application;
access network topology data associated with a network, wherein the network topology data identifies a set of network devices;
classify respective network devices of the set of network devices based on a type of network device and interface information associated with of the respective network devices;
determine default values based on the network topology data and classification of the respective network devices;
generate executable code for configuring the policy for the application on the network based on the default values; and
implementing the policy for the application on the network using the executable code.

11. The system of claim 10, wherein the at least one processor is further configured to execute the instructions to:
generating a graphical user interface (GUI) configured to display a network device of the set of network devices and selectable set of settings, wherein a set of default values associated with the network device is preselected in the selectable set of settings.

12. The system of claim 11, wherein the at least one processor is further configured to execute the instructions to:
receiving, from a user device via the GUI, a selection of a value of a setting of the selectable set of settings, wherein the value differs from a default value associated with the setting of the selectable set of settings;
modifying, based on the selection, the policy for the network; and
implementing the policy in the network after modifying the policy.

13. The system of claim 11, wherein the selectable set of settings comprises:
a set of applications;
a set of network policies; and
a set of network devices.

14. The system of claim 12, wherein modifying the policy for the network comprises updating the executable code based on the value of the settings, wherein the executable code is changed to modify the policy.

15. The system of claim 12, wherein receiving the selection of the value of the setting comprises receiving a selection of an application, a network policy, and a network device.

16. A non-transitory computer-readable storage medium comprising instructions that, when executed by at least one processor, cause the at least one processor to:
receive a request for a policy, wherein the request indicates an application;
access network topology data associated with a network, wherein the network topology data identifies a set of network devices;
classify respective network devices of the set of network devices based on a type of network device and interface information associated with of the respective network devices;
determine default values based on the network topology data and classification of the respective network devices;
generate executable code for configuring the policy for the application on the network based on the default values; and
implement the policy for the application on the network using the executable code.

17. The non-transitory computer-readable storage medium of claim 16, wherein execution of the instructions further cause the at least one processor to:
generate a graphical user interface (GUI) configured to display a network device of the set of network devices and selectable set of settings, wherein a set of default values associated with the network device is preselected in the selectable set of settings.

18. The non-transitory computer-readable storage medium of claim 17, wherein execution of the instructions further cause the at least one processor to:
receive, from a user device via the GUI, a selection of a value of a setting of the selectable set of settings, wherein the value differs from a default value associated with the setting;
modify, based on the selection, the policy for the network; and
implement the policy in the network after modifying the policy.

19. The non-transitory computer-readable storage medium of claim 17, wherein the selectable set of settings comprises:
a set of applications;
a set of network policies; and
a set of network devices.

20. The non-transitory computer-readable storage medium of claim 18, wherein modifying the policy for the network comprises generating executable code based on the value of the setting, wherein the executable code is changed to modify the policy.
